(19) United States
(12) Patent Application Publication
(10) Pub. No.: US 2026/0281143 A1
(43) Pub. Date: Sep. 17, 2026

(54) WEBSITE DETECTION METHOD AND APPARATUS, AND ELECTRONIC DEVICE AND READABLE MEDIUM

(71) Applicant: Beijing Volcano Engine Technology Co., Ltd., Beijing (CN)

(72) Inventors: Wenda HOU, Beijing (CN); Jian YANG, Beijing (CN); Yunjie PANG, Beijing (CN); Shaohua CHEN, Beijing (CN); Yunpeng SUN, Beijing (CN)

(21) Appl. No.: 19/471,352

(22) PCT Filed: Aug. 19, 2024
(86) PCT No.: PCT/CN2024/112979

§ 371 Date: Sep. 30, 2025

(30) Foreign Application Priority Data
Aug. 28, 2023 (CN) 202311092682.9

(51) Int. Cl. H04L 9/40

(52) U.S. Cl. CPC H04L 63/1433

(57) ABSTRACT

The present application discloses a website detection method, an apparatus, an electronic device, and a readable medium. The method includes: obtaining website information of a first website in response to a first file with a security protection attribute being sent out from a target browser on an office terminal to the first website; determining, based on the website information of the first website, whether the first website matches a pre-configured website audit strategy, and if the first website matching a pre-configured website, generating an audit result including the website information of the first website, where the audit result is used to indicate that, on the target browser, there exists a behavior with a security risk of sending out the target file with the security protection attribute to the first website.

### CROSS-REFERENCE TO RELATED APPLICATION(S)

This application is a U.S. National Stage Application of PCT Application Serial No. PCT/CN 2024/112979, filed Aug. 19, 2024, which claims priority to Chinese Patent Application No. 202311092682.9, entitled “WEBSITE DETECTION METHOD AND APPARATUS, AND ELECTRONIC DEVICE AND READABLE MEDIUM”, filed on Aug. 28, 2023, the entire disclosures of which are hereby incorporated by reference in their entireties.

### FIELD

The present application relates to the field of network security technologies, and in particular, to a website detection method, an apparatus, an electronic device, and a readable medium.

### BACKGROUND

Enterprise staffs may use an office terminal for office work. In many scenarios, the staffs may send some files to websites through a browser on the office terminal. However, for network security and enterprise information security, it is usually necessary to detect whether the sent files are secure, and when it is determined that the sent files may cause insecurity, detect whether the websites that receive the sent files are secure.

At present, manners of detecting whether the website that receives the sent file is secure include: manner 1, detection by means of traffic analysis; and manner 2, detection by means of browser intrusion.

### SUMMARY

To solve the above technical problem, the present application provides a website detection method, an apparatus, an electronic device, and a readable medium.

In order to achieve the above objective, the technical solutions provided in the present application are as follows:

A first aspect provides a website detection method, and the method may include:
obtaining website information of a first website to which a target file is sent out in response to an event that the target file is sent out through a target browser, where the target browser is a pre-configured browser allowed to be detected, and the target file is a file that is pre-configured with a security protection attribute;
determining whether the first website matches a pre-configured website audit strategy based on the website information of the first website, where the website audit strategy is used to indicate a category of websites that is allowed or not allowed to be audited; and
generating an audit result in response to the first website matching the website audit strategy, where the audit result is used to indicate that, on the target browser, there exists a security risk that the target file is leaked to the first website.

In some possible implementations, the method may further include:
providing a website audit strategy configuration channel; and
receiving the website audit strategy configured through the website audit strategy configuration channel, where the website audit strategy indicates a first category of websites to be skipped from auditing and/or a second category of websites that must be audited.

In some possible implementations, the method may further include:
providing two audit modes including a first audit mode and a second audit mode, where the first audit mode is used to indicate that all behaviors of sending out to external websites are audited, and the second audit mode is used to indicate that behaviors of sending out to specified websites are audited, and where the second audit mode supports configuring and updating the specified websites; and
determining a selected audit mode as the pre-configured website audit strategy.

In some possible implementations, the method may further include:
obtaining an event of operating a file through the target browser, excluding an event of performing a predefined secure operation through the target browser, and determining whether the event of sending out the target file through the target browser occurs, where the secure operation includes at least one of: opening a local file by a browser, loading a browser plugin, loading a browser extension, and sending to a local server.

In some possible implementations, obtaining the website information of the first website to which the target file is sent out may include at least one of the following:
obtaining the website information of the first website based on user interface (UI) Automation callback information;
obtaining the website information of the first website by invoking accessibility (Accessibility); obtaining the website information of the first website by invoking core Graphics (Choreographics); and
obtaining the website information of the first website by parsing a session (Session) file, where the Session file is obtained by backup after Session update of the target browser is monitored.

In some possible implementations, the method may further include:
providing a browser audit configuration channel, where the browser audit configuration channel provides all browsers installed on the office terminal for selection and configuration; and determining a selected browser as the browser that is allowed to be detected.

In some possible implementations, the method may further include:
generating and reporting an alarm, where the alarm includes the website information of the first website, and the website information of the first website includes at least one of: a uniform resource locator (URL), a website name, and a webpage title.

In some possible implementations, the method may further include:
Blocking, on the target browser, a response of the first website to operate the target file.

In some possible implementations, obtaining the website information of the first website to which the target file is sent out may include:
triggering obtaining of the website information of the first website after a preset time elapses from it perceiving occurrence of the event of sending the target file through the target browser.

A second aspect further provides a website detection apparatus, and the apparatus includes:
an obtaining unit, configured to obtain website information of a first website to which a target file is sent out in response to an event that the target file is sent out through a target browser, where the target browser is a pre-configured browser allowed to be detected, and the target file is pre-configured to have a security protection attribute;
a first determination unit, configured to determine whether the first website is a target audit website based on a pre-configured website audit strategy and the website information of the first website, where the website audit strategy is used to indicate whether a category of websites is allowed to be audited; and
a first-generation unit, configured to generate an audit result when the first website is the target audit website, where the audit result is used to indicate, on the target browser, there exists a security risk that the target file is leaked to the first website.

In some possible implementations, the apparatus may further include:
a first provision unit, configured to provide a website audit strategy configuration channel; and
a reception unit, configured to receive the website audit strategy configured through the website audit strategy configuration channel, where the website audit strategy indicates a first category of websites to be skipped from auditing, and/or a second category of websites that must be audited.

In some possible implementations, the apparatus may further include:
a second provision unit, configured to provide two audit modes including a first audit mode and a second audit mode, where the first audit mode is used to indicate that all behaviors of sending out to external websites are audited, and the second audit mode is used to indicate that behaviors of sending out to specified websites are audited, and where the second audit mode supports configuring and updating the specified websites; and
a second determination unit, configured to determine a selected audit mode as the pre-configured website audit strategy.

In some possible implementations, the apparatus may further include:
an exclusion unit, configured to obtain an event of operating a file through the target browser, exclude an event of performing a predefined secure operation through the target browser, and determine whether the event of sending out the target file through the target browser occurs, where the secure operation includes at least one of: opening a local file by a browser, loading a browser plugin, loading a browser extension, and sending to a local server.

In some possible implementations, the obtaining unit is further configured to perform at least one of the following:
obtaining the website information of the first website based on UI Automation callback information;
obtaining the website information of the first website by invoking Accessibility;
obtaining the website information of the first website by invoking Choreographics; and
   obtaining the website information of the first website by parsing a Session file, where the Session file is obtained through backup after Session update of the target browser is monitored.

In some possible implementations, the apparatus may further include:
a third provision unit, configured to provide a browser audit configuration channel, where the browser audit configuration channel provides all browsers installed on an office terminal for selection and configuration; and
a third determination unit, configured to determine a selected browser as the browser that is allowed to be detected.

In some possible implementations, the apparatus may further include:
a second-generation unit, configured to generate an alarm, where the alarm includes the website information of the first website, and the website information of the first website includes at least one of: a URL, a website name, and a webpage title; and
a sending unit, configured to report the alarm.

In some possible implementations, the apparatus may further include:
a blocking unit, configured to block, on the target browser, a response to the first website operating the target file.

In some possible implementations, the obtaining unit is further configured to:
trigger obtaining of the website information of the first website after a preset time has elapsed from perceiving occurrence of the event of sending the target file through the target browser.

It should be noted that, for details on the specific implementations of this apparatus and the technical effects achieved, please refer to the relevant description of the method provided in the first aspect or any implementation of the first aspect.

A third aspect further provides an electronic device, and the electronic device includes a processor and a memory;
where the memory is configured to store instructions or a program; and
the processor is configured to execute the instructions or the program in the memory to cause the electronic device to perform the method provided in the above target aspects or any implementation of the target aspects.

A fourth aspect further provides a readable medium, where the readable medium stores instructions or a program that, when executed by a processor, causes the processor to perform the method provided in the above target aspects or any implementation of the target aspects.

A fifth aspect further provides a computer program product including instructions that, when executed by a processor, cause the method provided in the above target aspects or any implementation of the target aspect is implemented.

In the technical solutions provided in the present application, an user's office terminal includes an audit client, and if the user sends out a target file through a target browser of the office terminal, website information of a first website which receives the target file is obtained, where the target browser is a pre-configured browser allowed to be detected, and the target file is pre-configured to have a security protection attribute; then, it is determined whether the first website matches a pre-configured website audit strategy based on the website information of the first website, where the website audit strategy is used to indicate whether a category of websites is allowed to be audited; and an audit result is generated when the first website matches the website audit strategy, where the audit result is used to indicate that, on the target browser, there exists a security risk that the target file is leaked to the first website.

### BRIEF DESCRIPTION OF THE DRAWINGS

In order to more clearly describe the technical solutions in the embodiments of the present application or in the prior art, the following briefly introduces the drawings that are used in the description of the embodiments or the prior art. Apparently, the drawings in the following description show merely some embodiments of the present application, and a person of ordinary skill in the art may still derive other drawings from these drawings without creative efforts.

FIG. 1 is a schematic flowchart of a website detection method according to an embodiment of the present application;

FIG. 2 is a schematic diagram of a configuration page according to an embodiment of the present application;

FIG. 3 is a schematic diagram of a customized selection page according to an embodiment of the present application;

FIG. 4 is a schematic diagram of a new website page according to an embodiment of the present application;

FIG. 5 is a schematic diagram of a detection process according to an embodiment of the present application;

FIG. 6 is a schematic diagram of a detection process performed by an audit client according to an embodiment of the present application;

FIG. 7 is a schematic signaling diagram of a detection process performed by an audit client according to an embodiment of the present application;

FIG. 8 is a schematic diagram of an overall process of website detection according to an embodiment of the present application;

FIG. 9 is a schematic diagram of a structure of a website detection apparatus 900 according to an embodiment of the present application; and

FIG. 10 is a schematic diagram of a structure of an electronic device 1000 according to an embodiment of the present application.

### DETAILED DESCRIPTION OF EMBODIMENTS

Enterprise employees may perform operations such as uploading files, downloading files, or creating files on the office terminal, and some files need to be prevented from being made public. For example, once files such as employee personnel information, customer information, or confidential business data are made public, it will affect the information security of employees or customers at least, and cause immeasurable losses to the enterprise in terms of business competition or social evaluation at most. Therefore, it is very necessary to detect behaviors of the enterprise employees on the office terminal.

In some cases, enterprise employees may access various websites through a browser installed on the office terminal and send out files to the websites, which poses a security risk. The websites may include, for example, but are not limited to, personal network disks, social forums, code hosting websites, or employee personal network attached storage (NAS), etc. In the embodiments of the present application, the current website detection schemes in this case are studied, and the discovered deficiencies and related descriptions are as follows.

At present, the website detection schemes may be divided into two categories: manner 1, detection by means of traffic analysis; and manner 2, detection by means of browser intrusion. The detection idea of manner 1 may be mainly summarized as: deploying a traffic detection system on the office terminal or at a network egress (that is, an enterprise intranet gateway), where the traffic detection system is configured to detect an outbound request for a file or information at risk. In some possible implementations of manner 1, the original transport layer security (TLS) certificate on the browser of the office terminal needs to be replaced with a trusted certificate, which not only makes the certificate replacement perceivable by the user, but also affects the performance of the user accessing the website through the browser. In some other possible implementations of manner 1, traffic hijacking to the traffic detection system is required. However, in the case applicable to the embodiments of the present application, the network environment may be an enterprise intranet, a home broadband, or a public place Wi-Fi, etc. When the office terminal is in a non-enterprise intranet environment, the traffic will not be hijacked to the detection gateway connected to the traffic detection system, and thus will not be detected by the traffic detection system. In some other possible implementations of manner 1, when the office terminal is in a non-enterprise intranet environment, the traffic is introduced into the enterprise intranet by means of configuring a proxy or a tunnel on the office terminal. However, this implementation may conflict with other network services locally on the office terminal on the one hand, and generate additional traffic costs on the other hand, thereby affecting the user's office experience. The detection idea of manner 2 may be mainly summarized as: detecting webpage information of a website on a browser and a user's outbound operation based on the browser on the office terminal. In some possible implementations of manner 2, detection is implemented by installing a plugin or an extension on the browser. In this implementation, the user may see the installation state of the browser plugin or extension, and may manually uninstall the plugin or the extension. In some other possible implementations of manner 2, detection is implemented by means of hooking a browser process. However, this implementation may affect the stability of the browser, and may cause problems such as browser crashes, thereby affecting the user's normal use of the browser. Moreover, for manner 2, due to the wide variety of browsers, high requirements are placed on the compatibility of plugins, extensions or hooks, and the upgrade and maintenance costs are high. Moreover, when the website information of a website with security risks is obtained, the website information may only be used as supplementary information for the alarm, and operators are required to perform secondary screening from massive alarms, which not only increases the operation and maintenance costs, but also easily leads to the omission of security risks, which is not conducive to network security.

In view of the fact of accessing a website through a browser installed on an office terminal and sending files or information to the website, an embodiment of the present application designs a website detection method that can solve the deficiencies of the current website detection schemes. An audit client is installed on the user's office terminal, and if the user sends a target file with a security protection attribute to a first website through a target browser of the office terminal, the audit client may obtain website information of the first website to which the target file is sent out in response to an event that the target file is sent out through the target browser, where the target browser is a pre-configured browser allowed to be detected; then, it is determined whether the first website matches a pre-configured website audit strategy based on the website information of the first website, where the website audit strategy is used to indicate whether a category of websites that is allowed to be audited; and if the first website matches the website audit strategy, the audit client generates an audit result, where the audit result is used to indicate that, on the target browser, there exists a security risk that the target file is leaked to the first website. Based on this, it is urgent to provide a detection solution that cannot be perceived by users and that may maintain enterprise information security and detect whether the website that receives the sent file is secure.

In this way, without affecting the user's use of the browser on the office terminal, by installing the audit client on the office terminal and a pre-configuring the website audit strategy on the audit client for indicating whether the category of websites is allowed to be audited, when the target file with security risks is sent out to a certain website through a certain browser, the audit client may be triggered to obtain the website information of the website, and determine whether the website matches the website audit strategy. If it matches, the audit client may consider that the behavior of sending the target file to the website through the browser has security risks, and thus generate the audit result to indicate that, on the browser, there exists a security risk that a file is leaked to the website, thereby completing a security detection of the website, accurately detecting the website to which the file with security risks is sent out through the browser, and providing a reliable basis for subsequent alarming and security maintenance.

It should be noted that the office terminal may refer to a terminal device used by enterprise employees for office work, for example, a notebook computer or a desktop computer. The office terminal may be understood as a terminal device that belongs to an enterprise and that the enterprise has the right to supervise and manage. The monitoring and management behaviors belong to an act agreed between the enterprise and the enterprise employees and does not involve personal privacy, and is limited to maintaining information security and network security of the enterprise, the enterprise employees, and enterprise customers, etc. The operating system of the office terminal may be: Windows, macOS, or Linux. The audit client may also be referred to as a detection client, and refers to a client installed on the office terminal for detecting whether there are security risks in the behavior of sending out files with security risks to a certain website through a browser. Managers or operators may configure a website audit strategy on an interface connected to an audit server corresponding to the audit client. After the configuration of the website audit strategy is completed, the audit client always runs in the backend when the office terminal is powered on, and the audit client performs website detection based on the website audit strategy, and discovers a security risk, on the browser, that a file is leaked to a certain website.

In the embodiments of the present application, the file may be understood as a generalization of all content that may be sent out through the browser. The file may include, for example, at least one of the following: a document, picture information, video information, text information, etc.

It should be noted that the entity that implements the website detection method may be the website detection apparatus provided in the embodiments of the present application, and the website detection apparatus may include the audit client, or the website detection apparatus may interact with the audit client, or the website detection apparatus may be understood as the audit client itself. The website detection apparatus may be carried in an electronic device or a functional module of the electronic device. The electronic device may be installed with the audit client, or may access the audit client.

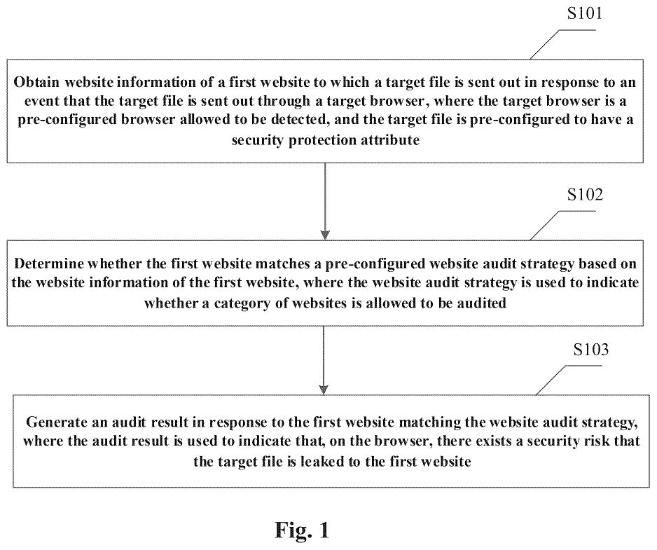

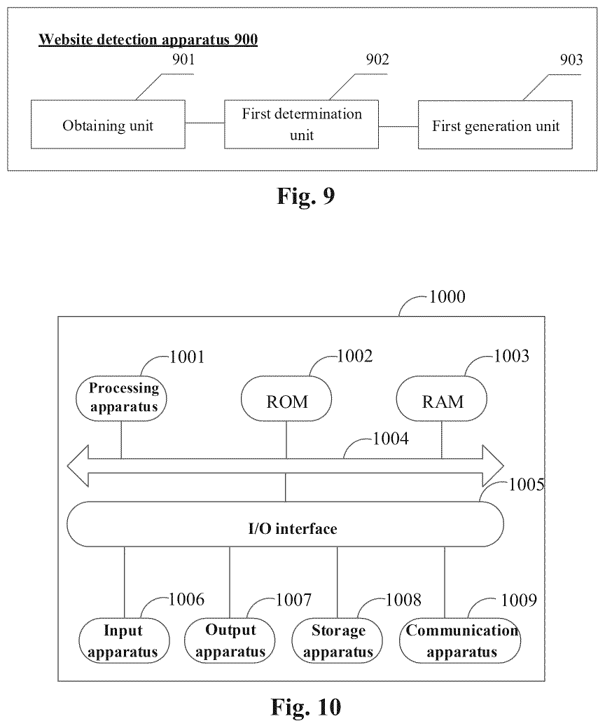

FIG. 1 is a schematic flowchart of a website detection method according to an embodiment of the present application. The method may be applied to a website detection apparatus, and the website detection apparatus may be, for example, a website detection apparatus 900 shown in FIG. 9 below. Since the website detection apparatus may include the audit client, interact with the audit client, or refer to the audit client, it may also be considered that the method is applied to the audit client, and the office terminal where the audit client is located may further include at least a target browser.

As shown in FIG. 1, the method may include, for example, the following S101 to S103:

At S101, website information of a first website to which a target file is sent out is obtained, in response to an event that the target file is sent out through a target browser, where the target browser is a pre-configured browser allowed to be detected, and the target file is a file is pre-configured to have a security protection attribute.

The target file may be understood as a file with a security protection attribute. The file with the security protection attribute may be understood as containing data that needs to be kept confidential, such as personal information, customer information, internal codes, or other confidential business data. The secure access attribute may be an attribute label marked for the file in advance, and the attribute label is used to represent whether the file needs security protection, that is, whether the file is allowed to be sent out to an external website. The security protection attribute may also be analyzed and determined based on the content of the file itself, for example, when the file contains a preset security attribute keyword, it is determined that the file has the security protection attribute. Taking a mobile phone number as an example, in one case, the security protection attribute may be an attribute of the mobile phone number, for example, the security protection attribute may include an attribute of 11 digits and starting with specific symbols such as 130, 131, 132, 135, 137, 138, 150, 152, etc. Then, if the outbound file includes a part that matches the security protection attribute, the sent file may be understood as a target file with the security protection attribute. In another case, the security protection attribute may be an attribute label of “mobile phone number”. If the outbound file includes the attribute label of “mobile phone number”, or if it is determined by analyzing the content of the outbound file that may be added with the attribute label of “mobile phone number”, the outbound file may be understood as the target file with the security protection attribute.

The terms “send out” or “outbound” may relate to an action of opening and reading the target file.

In order to facilitate configuration by managers or operators, an audit server corresponding to the audit client provides an interface, and the interface provides a configuration page where the managers or operators may configure the website audit strategy of the audit client. The configuration page includes at least a configuration item for the website audit strategy. In addition, the configuration page may further include configuration items for a browser audit strategy.

As an example, the configuration page may further provide a choice between two audit modes, and a selected audit mode is determined as the pre-configured website audit strategy. The two audit modes may include a first audit mode and a second audit mode, and the first audit mode is used to indicate to audit all behaviors of sending out to external websites, and the second audit mode is used to indicate to behaviors of sending out to specified websites. The second audit mode supports configuring and updating the specified websites.

When the network audit strategy corresponds to the second audit mode, the configuration page may provide a website audit strategy configuration channel, and the audit client may receive a website audit strategy configured through the website audit strategy configuration channel, where the website audit strategy may indicate a first category of websites to be skipped from auditing, and/or indicate a second category of websites that must be audited. If only the first category of websites is configured, the specified websites in the second audit mode may be websites obtained by excluding the first category of websites from all external websites. If only the second category of websites is configured, the specified websites in the second audit mode may be the second category of websites. If both the first category of websites and the second category of websites are configured, the specified websites in the second audit mode may be websites that belong to the second category of websites but do not belong to the first category of websites.

As an example, the configuration page may further provide a browser audit configuration channel, and the browser audit configuration channel provides all browsers installed on the office terminal for selection and configuration, for example, a browser may be selected as being allowed to be detected. The audit client may receive the browser that is allowed to be detected and that is configured through the browser audit configuration channel, and the browser that is allowed to be detected includes the target browser at S101.

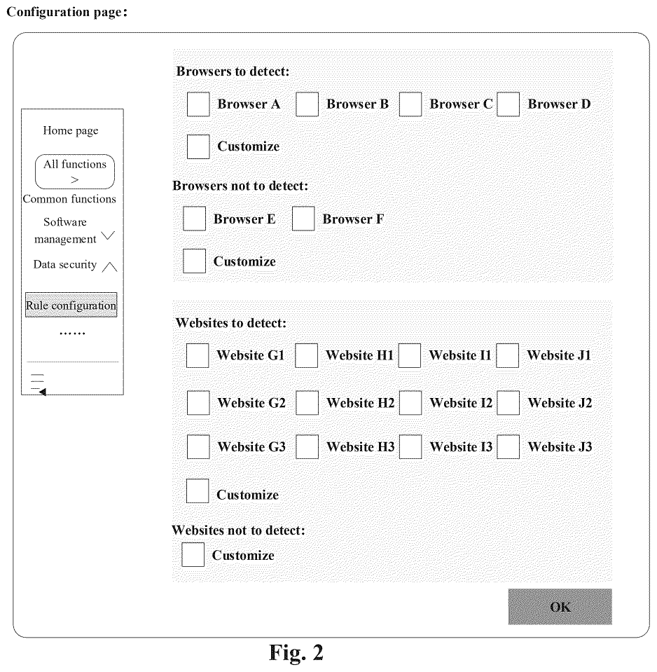

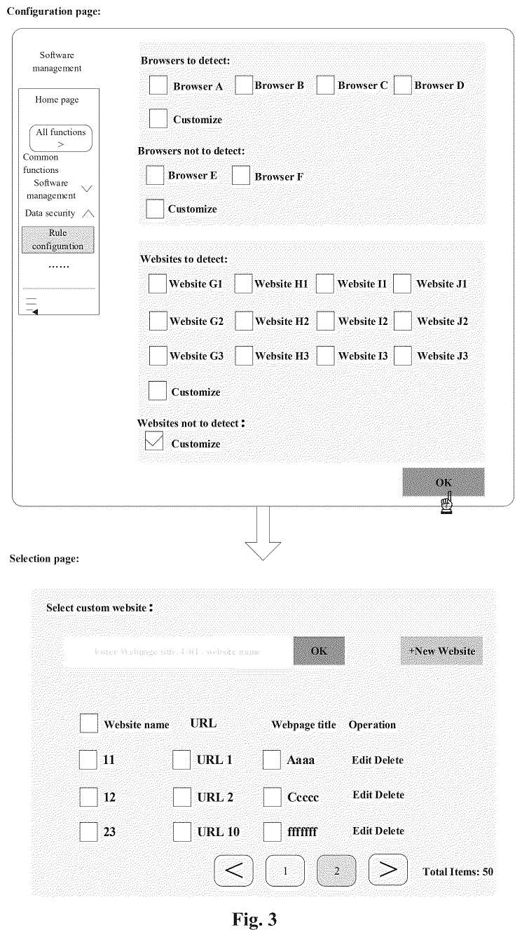

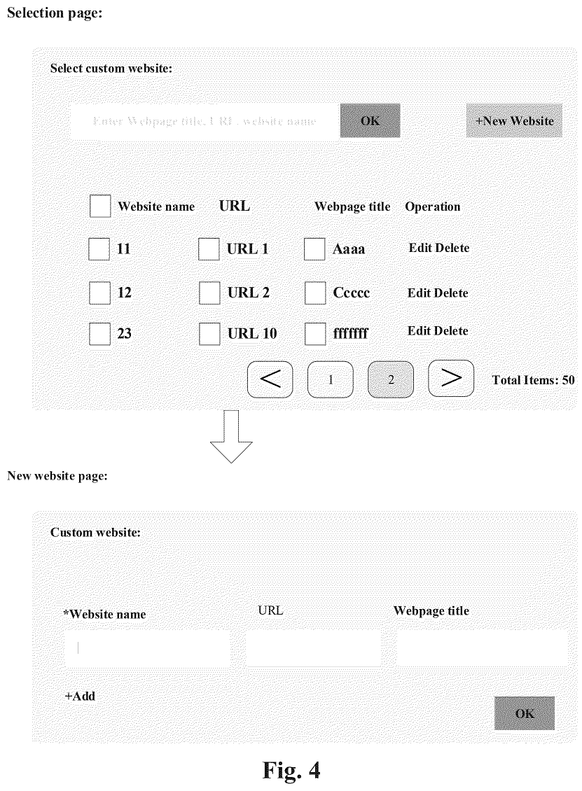

For example, FIG. 2 shows a schematic diagram of a configuration page. As shown in FIG. 2, the configuration page may include a configuration part of browsers that need to be detected, a configuration part of websites that need to be detected, and a configuration part of websites that do not need to be detected. In addition, the configuration page may further include a configuration part of browsers that do not need to be detected. Each configuration part may include at least one option and/or one “customize” button. The user may select the option by clicking or double-clicking on a selection box corresponding to the option or may select the option by double-clicking on the selection box corresponding to the option. The user may also click on the “customize” button to enter a selection page for customizing a browser or a website. FIG. 3 shows a selection page by taking the selection page for customizing a website as an example, and the selection page includes at least one saved customized website. Each customized website may include at least one of the following information: a URL, a webpage title, or a website name, and the website name may be custom-configured by the user, and an edit or delete action may be performed on each customized website. In addition, the selection page shown in FIG. 3 may further include a “new website” option. When the user clicks on the “new website” option, the selection page jumps to the newly added website page shown in FIG. 4. The user may input at least one of the URL, the webpage title, or the website name of the website to be input on the newly added website page, and by clicking on the “OK” button, the action of adding the new website is completed. The newly added website page is closed, the selection page shown in FIG. 3 is displayed, and the newly added website may become a custom website maintained on the selection page shown in FIG. 3. In order to facilitate the user to select a custom website, the custom websites in the selection page shown in FIG. 3 may be sorted in a chronological order of the creation of the custom websites, for example, the newly added website this time may be displayed at the top.

As an example, if the browser audit configuration channel is not provided on the display page, that is, there is no function of configuring a browser set, the audit client may detect all browsers installed on the office terminal by default. Then, at S101, the target browser may be any browser on the office terminal, that is, no matter which browser on the office terminal the user uses to send out the target file to the first website, the website information of the first website is triggered to be obtained.

As another example, if the browser audit configuration channel is provided on the display page, that is, there is a function of configuring a browser set, S101 may include, for example: in response to an event that the target file is sent out through the target browser, determining whether the target browser matches a browser configured through the browser audit configuration channel, and if it matches, obtaining the website information of the first website to which the target file is sent out; and if it does not match, no longer obtaining the website information of the first website to which the file is sent out and performing the subsequent steps S102 to S103, and terminating this detection. The browser set is used to indicate browsers that need to be detected. In one case, the configuration page prompts to configure a browser set that does not need to be detected, then each one in the browser set do not need to be detected, and the browser set indirectly indicates the browsers that need to be detected. The target browser matching the browser set configured through the browser audit configuration channel may indicate that the target browser does not belong to the configured browser set. In another case, the configuration page prompts to configure a browser set that needs to be detected, then each one in the browser set that need to be detected, and the browser set directly indicates the browsers that need to be detected. The target browser matching the browser set configured through the browser audit configuration channel may indicate that the target browser belongs to the configured browser set. In yet another case, the configuration page prompts to configured browser sets includes a first category of browsers that need to be detected and a second category of browsers that do not need to be detected, then the target browser matching the browser set configured through the browser audit configuration channel may indicates that the target browser does not belong to the second category of browsers and belongs to the first category of browsers. In this way, the display page may flexibly design the function of configuring the browser set according to actual needs, to implement detection and filtering in a browser dimension, and the website detection method provided in the embodiments of the present application is only executed for the behavior of sending out the target file through the browser that matches the browser set, thereby making the website detection method more intelligent.

It should be noted that, in the embodiments of the present application, to make the website detection more accurate, after the event of operating the file through the target browser is obtained, an event of performing a predefined secure operation through the target browser may be excluded, and whether the occurrence of the event of sending out the target file through the target browser is determined. If it is determined that the event of sending out the target file through the target browser occurs, the method provided in the embodiments of the present application is executed to implement website detection; and if it is determined that the event of sending out the target file through the target browser does not occur and that it belongs to the predefined secure operation, it is considered unnecessary to execute the method provided in the embodiments of the present application. The predefined secure operation may include at least one of the following: opening a local file by a browser, loading a browser plugin, loading a browser extension, and sending to a local server. For different types of secure operations, the timing of performing the above exclusion step may be flexibly set. For example, the secure operation of loading the browser plugin or loading the browser extension may be performed before S101; and the secure operation of opening the local file by the browser or sending to the local server may be performed after S101 and before S102.

In some implementations, it is considered that the operation on the target file may not only be an outbound action, but also an action of loading a browser plugin caused by the plugin or an action of loading a browser extension caused by the extension. Specifically, a configuration file of the browser usually records an installation location of the installed plugin or extension, and the browser may read the path corresponding to the installation location of the plugin or the extension when loading the plugin or the extension, and the action of reading the path corresponding to the installation location of the plugin or the extension may also be perceived by the audit client as the behavior of sending out the target file to the first website on the target browser. Therefore, in order to improve the accuracy of website detection and avoid false reports due to extension or plugin loading, after the audit client perceives the event of operating the file on the target browser and before obtaining the website information of the first website, the method may further include: determining, based on the configuration file of the target browser, whether the operation belongs to the action of loading the browser plugin or the browser extension, and if it belongs to, no longer obtaining the website information of the first website and terminating the subsequent steps S102 to S103, and if it does not belong to, triggering to obtain the website information of the first website.

The website information of the first website may include, but is not limited to, at least one of: a URL, a website name, and a webpage title.

In some implementations, the website information of the first website, for example, may be obtained from the cache information for the browser. Since the cache information for the browser is near real-time rather than absolutely real-time, there is a certain delay. Therefore, in order to ensure that the website information of the first website obtained at S101 is not the website information of other websites previously cached, obtaining the website information of the first website at S101 may include, for example: triggering obtaining of the website information of the first website after a preset time (such as 2 seconds) has elapses from perceiving occurrence of the event of sending out the target file through the target browser. In this way, the situation that the cache information does not match the website information of the first website to be detected, which is caused by opening the browser with “right-click-open” or the like, can be optimized, and the problem of inaccuracy in the obtained website information of the first website may be overcome.

As an example, obtaining the website information of the first website at S101 includes at least one of the following: a, obtaining the website information of the first website based on UI Automation callback information, and the registered UI Automation notifies the audit client to cache the callback information when a component of the target browser changes; b, obtaining the website information of the first website by invoking Accessibility; c, obtaining the website information of the first website by invoking CoreGraphics; and d, obtaining the website information of the first website by parsing a Session file, where the Session file is obtained through backup after a Session update of the target browser is monitored. UI Automation, Accessibility, and CoreGraphics may all be understood as interfaces opened by the operating system of the office terminal for the target browser, and the Session file may be understood as a type of file in the file system of the office terminal. Before the audit client starts to perform detection, the audit client monitors a browser start or exit event and registers a UI Automation notification callback, so that the audit client is notified to cache the callback information when the browser component changes. For manner a, the cached UI Automation callback information may be directly read. In addition, the audit client also monitors the update of the Session file in the browser, and performs a backup operation after the update of the Session file in the browser has written, to record a current browsing state. For manner d, the Session file may be directly read and parsed to obtain the website information of the first website.

In a specific implementation, S101 may obtain the website information of the first website based on any one or more of the above a, b, c, and d. If the website information of the first website is obtained based on two or more manners, a corresponding priority may be set for each manner based on the accuracy of the website information obtained based on the plurality of manners, to ensure that when the same information item (such as a URL) is obtained based on the plurality of manners but the specific information is different, the website information of the first website may be determined based on the priority corresponding to each manner, and each information item in the determined website information has unique specific information. For example, the website information of the target website is obtained based on manner a and manner b, the priority of manner b is higher than the priority of manner a, URL 2 is obtained based on manner a, and URL 1 and webpage title 1are obtained based on manner b, then the obtained website information of the first website based on manners a and b may include: URL 1 and webpage title 1.

Moreover, the determined website information may be an information item of the website information obtained based on each manner. For example, the website information of the first website is obtained based on manner a and manner b, URL 1 and website name 1 of the first website are obtained based on manner a, and URL 1 and webpage title 1 of the first website are obtained based on manner b, then the obtained website information of the first website based on manners a and b may include: URL 1, webpage title 1, and website name 1.

It may be seen that the website information of the first website obtained by S101 provides a data basis for implementing website detection based on the embodiments of the present application.

At S102, it is determined that whether the first website matches a pre-configured website audit strategy based on the website information of the first website, where the website audit strategy is used to indicate whether a category of websites is allowed to be audited.

In some implementations, it is considered that the operation on the target file on the target browser may not only be an outbound action, but also a local operation such as opening a local file or sending to a local server. Specifically, the browser may be used as a reader of a file in a certain format (such as a portable document format (PDF)), then the website information of the first website accessed may include a local path of a file in this format stored locally; or, in the debugging stage of website development, a developer may open a local server through the browser to perform actions such as file uploading, and the above local operation actions may also be perceived by the audit client as the behavior of operating the target file by the first website on the target browser. Therefore, in order to improve the accuracy of website detection and avoid false reports caused by local operations, after the website information of the first website is obtained and before S102, it may be determined, based on the website information of the first website, whether the event of operating the file through the target browser belongs to an event of a local operation in a predefined secure operation, and if it belongs to, the subsequent steps S102 to S103 are no longer performed, and if it does not belong to, S102 is triggered to be performed.

As an example, if the website audit strategy corresponds to the first audit mode, no website set may be configured on the display page, and the audit client needs to detect all websites by default. Then, the first website may be any website that may be accessed on the target browser, that is, no matter which website the user sends out the target file to on the target browser of the office terminal, the determination result at S102 is considered to be yes, and S103 may be continuously performed.

As another example, if the website audit strategy corresponds to the second audit mode, a function of configuring a website set may be provided on the display page, and the website audit strategy indicates whether the category of websites is allowed to be audited based on the configured website set. S102 may include, for example: determining whether the first website matches the pre-configured website audit strategy based on the obtained website information of the first website, and if it matches, generating the audit result; and if it does not match, no longer performing the subsequent S103, and terminating this detection. The website audit strategy is used to indicate whether the category of websites is allowed to be audited. In one case, the configuration page prompts to configure a first category of websites that do not need to be detected (which may also be referred to as websites that need to be excluded or skipped from auditing), that is, the website audit strategy indicates the first category of websites to be skipped from auditing, and the first category of websites indirectly indicates the websites that need to be detected. The first website matching the website audit strategy may indicate that the first website does not belong to the first category of websites. In another case, the configuration page prompts to configure a second category of websites that need to be detected, that is, the website audit strategy indicates the second category of websites that must be audited, and the second category of websites directly indicates the websites that need to be detected. The first website matching the website audit strategy may indicate that the first website belongs to the second category of websites. In yet another case, the configuration page prompts to configure the first category of websites and the second category of websites, then the first website matching the website audit strategy may indicate that the first website does not belong to the first category of websites and belongs to the second category of websites. In this way, the display page may flexibly design the function of configuring the website set according to actual needs, to implement detection and filtering in a website dimension, and the website detection method provided in the embodiments of the present application is only executed for the behavior of sending out the target file to the website that matches the website set configured in the website audit strategy, thereby making the website detection method more intelligent.

It may be seen that at S102, by means of the pre-configured website audit strategy and the website information of the first website obtained at S101, it is determined whether sending out the target file that is unexcepted to be sent out to the first website is a behavior with security risks, and a detection rule (that is, the website audit strategy) is set and performed in the website dimension, thereby making the detection convenient and accurate.

At S103, an audit result is generated in response to the first website matching the website audit strategy, where the audit result is used to indicate that, on the browser, there exist a security risk that the target file is leaked to the first website.

In a specific implementation, when it is determined that the first website matches the website audit strategy, it may be determined that sending out the target file that is unexpected to be sent out to the first website on the target browser is a behavior with security risks, therefore, the audit result is generated, and the audit result may include at least the website information of the first website, which is used to inform the manager of the behavior of sending out the target file, and that the specific website where the behavior occurred is the first website.

In some possible implementations, in order to further prompt the enterprise of the security risks, the method may further include: generating alarm information based on the audit result, where the alarm information may include at least the website information of the first website, and the alarm information is used to indicate that there are security risks in the behavior of sending out the target file with the security protection attribute to the first website on the target browser; and sending out the alarm information to an audit server corresponding to the audit client. For example, the alarm information may include outbound information, and the outbound information may include: the URL, the webpage title, and the website name of the first website. In addition, the outbound information may further include at least one of the following information: an event identification, an outbound time, a reporting time, the target browser, screenshot evidence, a website audit strategy hit, or a security protection attribute hit. In addition, the alarm information may further include file information, and the file information may include, for example, at least one of the following: a file name, a file path, a file size, a file MD5, or a file type of the target file.

In some possible implementations, in order to further prompt the enterprise of the security risks, in addition to the alarm, the network and information security of the enterprise may be improved faster and more effectively by blocking, on the target browser, the response of the first website to operate the target file.

It may be seen that in this method, without affecting the user's use of the browser on the office terminal, by installing the audit client on the office terminal and pre-configuring the website audit strategy on the audit client, when a target file with a security protection attribute is sent out to a certain website through a certain browser, the audit client may be triggered to obtain the website information of the website, and determine whether the website matches the website audit strategy. If it matches, the audit client may consider that there are security risks in the behavior of sending out the target file to the website through the browser, and thus the audit result including the website information of the website is generated, thereby completing a security detection of the website, accurately detecting the website to which the file with security risks is sent out through the browser and obtaining the website information of the website, and preparing for reliable alarm and security maintenance of this situation.

In order to make the method provided in the embodiments of the present application clearer, a possible specific implementation will be exemplarily described below with reference to the drawings.

In an embodiment of the present application, the audit client of the office terminal detects that a first website of a browser performs a behavior of sending out a target file that is unexpected to be leaked, and extracts website information of the first website (including a URL and/or a webpage title of the first website) in a non-invasive manner, and detects the first website according to a pre-configured website audit strategy, and if an audit result is generated, corresponding alarm information is generated, and the alarm information is reported by the audit client to an audit server, and the alarm information is displayed by the audit server to a manager.

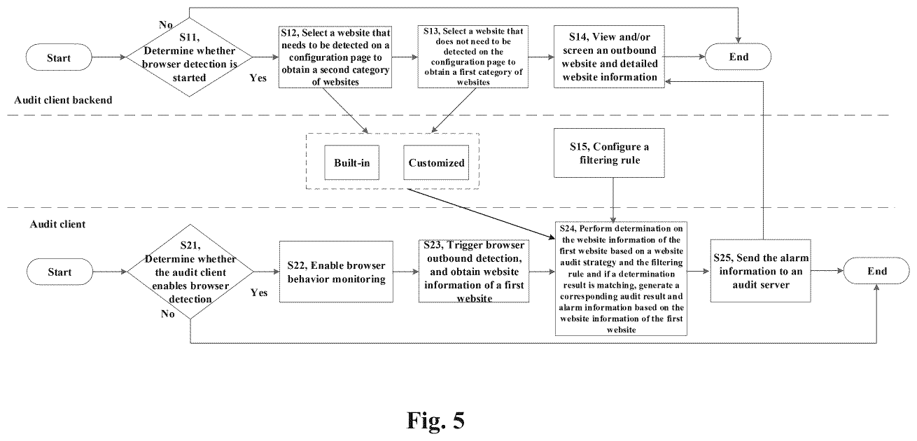

The above process may include: configuring the website audit strategy in the audit client backend and performing detection by the audit client, as shown in FIG. 5. The audit client backend may refer to an interface provided by an audit server corresponding to the audit client, and the interface may provide a configuration page (for example, see FIG. 2).

Taking the website audit strategy corresponding to the second audit mode as an example, as shown in FIG. 5, the process of configuring the website audit strategy in the audit client backend may include the following steps.

At S11, it is determined whether browser detection is started, and if yes, S12 and/or S13 is performed, otherwise the process is ended.

At S12, a website that needs to be detected is selected, on the configuration page, to obtain a second category of websites.

At S13, a website that does not need to be detected is selected, on the configuration page, to obtain a first category of websites.

The website at S12 and S13 may be a selected built-in website, such as a chat software, a network disk, a mailbox, a cloud note, a cloud document, a code escrow, or a forum; or it may be a custom website. When customizing the website, it is necessary to configure the URL and/or the webpage title of the website, and the website name may also be configured, where the URL supports regular matching.

It should be noted that the priority of the first category of websites is usually higher than the priority of the second category of websites, that is, during the detection process, the matching of the first category of websites is preferentially performed, and only when the first website does not belong to the first category of websites, the matching of the second category of websites is performed. Once the first website belongs to the first category of websites, the subsequent detection process is not performed. If it is determined that the first website does not belong to the first category of websites, it is then determined whether the first website belongs to the second category of websites. If the first website belongs to the second category of websites, the subsequent detection process is performed, and if the first website does not belong to the second category of websites, the subsequent detection process is not performed.

The above S12 to S13 may be considered as the configuration of the website audit strategy.

Optionally, the process may further include the configuration of a filtering rule, for example, it may include the following S14 to S15:

At S14, an outbound website and detailed website information are viewed and screened.

Optionally, the process may further include the following step.

At S15, a filtering rule is configured, where the filtering rule is used to filter a local operation of the browser and/or extension (or plugin) loading of the browser.

As shown in FIG. 5, the process of performing detection by the audit client may include the following steps.

At S21, it is determined whether the audit client enables browser detection, and if yes, S22 is performed, otherwise the process is ended.

At S22, browser behavior monitoring is enabled.

At S23, browser outbound detection is triggered, and website information (including a URL and a webpage title) of a first website is obtained.

At S24, determination on the website information of the first website is performed based on the website audit strategy and the filtering rule, and if a determination result is matching, a corresponding audit result and alarm information is generated based on the website information of the first website.

The phrase “if the determination result is matching” may be understood as: determining that the first website matches the website audit strategy based on the website information of the first website, and the behavior of sending out the target file to the first website does not belong to the secure operation indicated by the filtering rule.

At S25, the alarm information is sent to the audit server, to provide a data basis for the execution of S14.

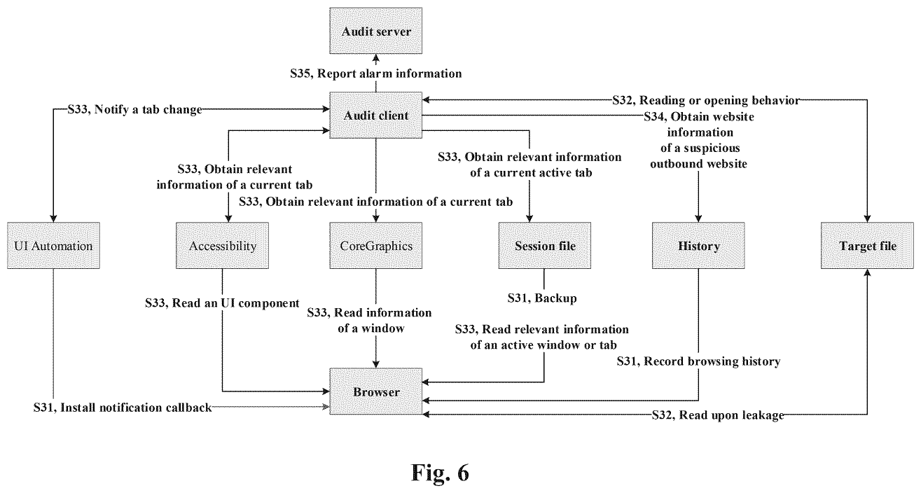

The detection process of the audit client on the office terminal, as shown in FIG. 6, may include the following steps.

At S31, after website detection is enabled, the audit client performs: (1) monitoring a browser start or exit event, registering a UI Automation notification callback, and notifying the audit client when a browser component changes; and (2) monitoring an update of a browser Session file, and performing a backup operation after the update is written, to record the current browsing state.

At S32, when the user sends out a target file through a first website, the audit client performs: (1) the browser opening or reading the target file, to trigger the audit client to start the detection process; and (2) the audit client determining that website information (which may also be referred as site information) of the first website needs to be obtained.

At S33, the audit client obtains the website information of the first website, including at least one of the following manners: (1) reading currently cached UI Automation callback information, to obtain relevant information of an active window or an active tab; (2) invoking Accessibility to check a window of the target browser, to obtain a URL and a webpage title of the first website; (3) invoking CoreGraphics to check the window of the target browser, to obtain a title (that is, the webpage title) of the window; and (4) parsing a backed up Session file, to obtain the relevant information of the active window or the active tab. (1) to (4) of S33 correspond to a to d of the method shown in FIG. 1 above, respectively.

At S34, the audit client performs detection according to the obtained website information of the first website and based on the website audit strategy including: (1) sequentially matching websites that need to be ignored (that is, a first category of websites) and websites that need to be detected (that is, a second category of websites) based on priorities, (2) if a website that need to be ignored is hit, skipping the current detection process; and (3) if a website that need to be detected is hit, continuing the current detection process to generate alarm information.

At S35, when generating the alarm information, the audit client may fill the website information of the first website into the alarm information, and report the alarm information to the audit server.

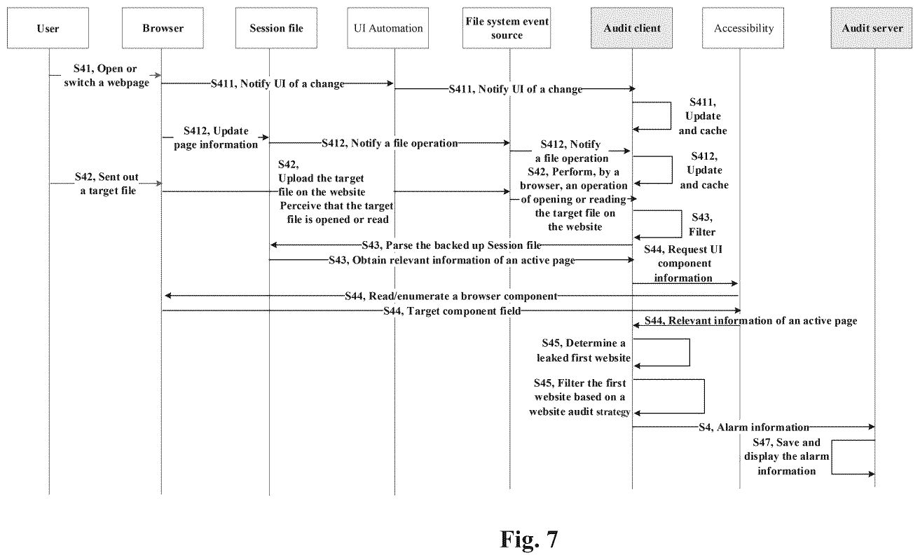

The detection process of the audit client on the office terminal, based on the signaling interaction process shown in FIG. 7, for example, may include the following steps.

At S41, the user opens or switches a browser webpage, and the browser performs: at S411, notifying UI Automation of a UI change, and the UI Automation notifies the audit client of the change, and the audit client updates and caches; and at S412, updating page information in a Session file, and the Session file notifies a file system event source of a file operation, and the file system event source notifies the audit client to update and back up.

At S42, the user sends out the target file on the browser, and the browser uploads the target file on the website, and the file system event source perceives that the target file is opened or read, and the file system event source notifies the audit client that the browser has an operation of opening or reading the target file on the website.

At S43, after general filtering is performed by the audit client, the backed up Session file is parsed to obtain relevant information of an active page.

At S44, the audit client requests to Accessibility for obtaining of UI component information, Accessibility reads or enumerates a component from the browser, the browser sends a target component field to Accessibility, and Accessibility returns the relevant information of the active page to the audit client.

At S45, the audit client determines that the first website is leaked, and filters the first website based on the website audit strategy.

At S46, the audit client generates the alarm information and sends the alarm information to the audit server when it is determined that there is a leakage risk.

At S47, the audit server saves and displays the alarm information.

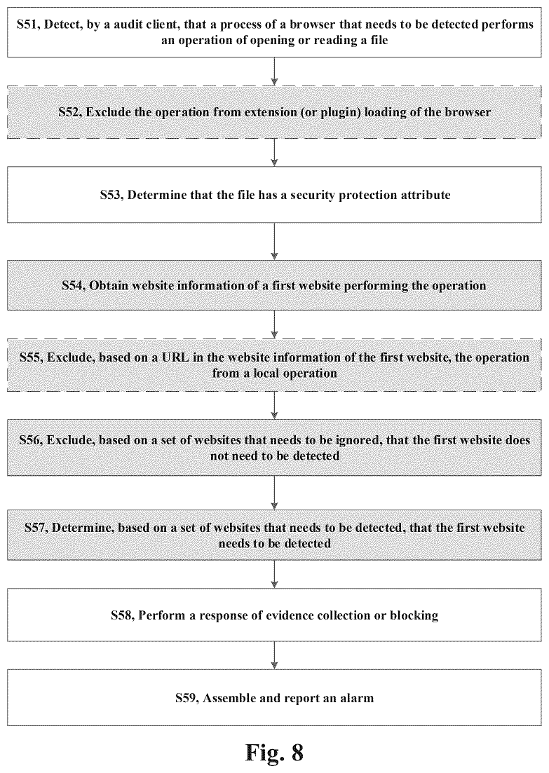

In order to make the process of website detection clearer, the overall process involved in website detection will be described below with reference to FIG. 8. As shown in FIG. 8, the overall process of website detection may include the following steps.

At S51, the audit client detects that a process of a browser that needs to be detected performs an operation of opening or reading a file.

At S52, the operation is excluded from extension (or plugin) loading of the browser.

At S53, the file is determined to have a security protection attribute.

At S54, website information of a first website performing the operation is obtained.

At S55, based on a URL in the website information of the first website, the operation is excluded from a local operation.

At S56, it is excluded, based on a set of websites that need to be ignored, that the first website does not need to be detected.

At S57, it is determined, based on a set of websites that need to be detected, that the first website needs to be detected.

At S58, a response such as evidence collection or blocking is performed.

At S59, an alarm is assembled and reported.

It should be noted that in the process shown in FIG. 8, S51, S53, S58, and S59 are general steps of website detection, and S52 and S54 to S57 are steps designed by the website detection method provided in the embodiments of the present application (corresponding to the steps shown in the gray background in FIG. 8), where S54, S56, and S57 are steps that must be performed, and S52 and S55 are optional steps for implementing the filtering rule.

It may be seen that, by means of the website detection method designed in the embodiments of the present application, the audit client may obtain the website information of the website to which the file is currently sent out in near real-time without being perceived by the user and without affecting the user's browser experience. When there are multiple browsers, multiple browser windows, personal profiles, or tabs at the same time, the website to which the file is currently sent out may be accurately located. When it is detected that a specific browser sends out a file, the website information of the corresponding website is obtained, and matching is performed based on the website information and the website audit strategy configured by the manager, and when a website that does not need to be detected is not hit and a website that needs to be detected is hit, the alarm information including the website information of the website is generated and reported to the audit server. In addition, in order to obtain a more accurate website detection result, the website detection method further includes the matching of the filtering rule, that is, actions such as opening a local file by the browser, loading a plugin, loading an extension, and sending to a local server are distinguished from sending out files, to avoid false reports.

Correspondingly, an embodiment of the present application further provides a website detection apparatus 900, as shown in FIG. 9, and the apparatus 900 may be applied to an audit client of an office terminal, and the office terminal further includes a target browser. The apparatus 900, for example, may include:
an obtaining unit 901, which is configured to obtain website information of a first website to which a target file is sent out in response to an event that the target file is sent out through the target browser, where the target browser is a pre-configured browser allowed to be detected, and the target file is pre-configured to have a security protection attribute;
a first determination unit 902, configured to determine whether the first website is a target audit website based on a pre-configured website audit strategy and the website information of the first website, where the website audit strategy is used to indicate whether a category of websites is allowed to be audited; and
a first generation unit 903, configured to generate an audit result when the first website is the target audit website, where the audit result is used to indicate that, on the target browser, there exists a security risk that the target file is leaked to the first website.

In some possible implementations, the apparatus 900 may further include:
a first provision unit, configured to provide a website audit strategy configuration channel; and
a reception unit, configured to receive the website audit strategy configured through the website audit strategy configuration channel, where the website audit strategy indicates a first category of websites to be skipped from auditing, and/or indicates a second category of websites that must be audited.

In some possible implementations, the apparatus 900 may further include:
a second provision unit, configured to provide two audit modes include a first audit mode and a second audit mode, where the first audit mode is used to indicate that all behaviors of sending out to external websites are audited, and the second audit mode is used to indicate that behaviors of sending out to specified websites are audited, and the second audit mode supports configuring and updating the specified websites; and
second determination unit, configured to determine a selected audit mode as the pre-configured website audit strategy.

In some possible implementations, the apparatus 900 may further include:
an exclusion unit, configured to obtain an event of operating a file through the target browser, exclude an event of performing a predefined secure operation through the target browser, and determine whether the event of sending out the target file through the target browser occurs, where the secure operation includes at least one of: opening a local file by a browser, loading a browser plugin, loading a browser extension, and sending to a local server.

In some possible implementations, the obtaining unit 901 is further configured to perform at least one of the following:
obtaining the website information of the first website based on UI Automation callback information;
obtaining the website information of the first website by invoking Accessibility;
obtaining the website information of the first website by invoking CoreGraphics; and
obtaining the website information of the first website by parsing a Session file, where the Session file is obtained by backup after Session update of the target browser is monitored.

In some possible implementations, the apparatus 900 may further include:
a third provision unit, configured to provide a browser audit configuration channel, where the browser audit configuration channel provides all browsers installed on the office terminal for selection and configuration; and
a third determination unit, configured to determine a selected browser as the browser that is allowed to be detected.

In some possible implementations, the apparatus 900 may further include:
a second generation unit, configured to generate an alarm, where the alarm includes the website information of the first website, and the website information of the first website includes at least one of: a URL, a website name, and a webpage title; and
a sending unit, configured to report the alarm.

In some possible implementations, the apparatus 900 may further include:
a blocking unit, configured to block, on the target browser, a response to the first website operating the target file.

In some possible implementations, the obtaining unit 901 is further configured to:
trigger obtain of the website information of the first website after a preset time has elapsed from perceiving occurrence of the event of sending out the target file through the target browser.

It should be noted that, the descriptions of the specific implementation of the apparatus 900 and the technical effects achieved may refer to the relevant description of the method shown in FIG. 1.

In addition, an embodiment of the present application further provides an electronic device, and the device includes a processor and a memory, where the memory is configured to store instruction s or a computer program, and the processor is configured to execute the instructions or the computer program in the memory to cause the electronic device to perform any implementation of the comment display method provided in the embodiments of the present application.

Referring to FIG. 10, it shows a schematic diagram of a structure of an electronic device 1000 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable media player (PMP), and a vehicle-mounted terminal (such as a vehicle navigation terminal), etc., and fixed terminals such as a digital television (TV) and a desktop computer, etc. The electronic device shown in FIG. 10 is only an example, and should not impose any limitation on the function and scope of use of the embodiments of the present disclosure.

As shown in FIG. 10, the electronic device 1000 may include a processing apparatus (such as, a central processing unit, and a graphics processing unit) 1001, which may perform various appropriate actions and processing according to a program stored in a read-only memory (ROM) 1002 or a program loaded from a storage apparatus 1008 into a random-access memory (RAM) 1003. In the RAM 1003, various programs and data required for operations of the electronic device 1000 are also stored. The processing apparatus 1001, the ROM 1002, and the RAM 1003 are connected to each other through a bus 1004. An input/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, and a gyroscope, etc.; an output apparatus 1007 including, for example, a liquid crystal display (LCD), a speaker, and a vibrator, etc.; the storage apparatus 1008 including, for example, a magnetic tape and a hard disk, etc.; and a communication apparatus 1009. The communication apparatus 1009 may allow the electronic device 1000 to perform wireless or wired communication with other devices to exchange data. Although FIG. 10 shows the electronic device 1000 with various apparatuses, it should be understood that not all the apparatuses shown herein need to be implemented or provided. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, and the computer program includes program codes for performing the method shown in the flowchart. In such an embodiment, the computer program may be downloaded from a network and installed by the communication apparatus 1009, or installed from the storage apparatus 1008, or installed from the ROM 1002. When the computer program is executed by the processing apparatus 1001, the functions defined in the method of the embodiments of the present disclosure are executed.

The electronic device provided in the embodiments of the present disclosure belongs to the same inventive concept as the method provided in the above embodiments. For the technical details not described in detail in this embodiment, reference may be made to the above embodiments, and this embodiment has the same beneficial effects as the above embodiments.

An embodiment of the present application further provides a computer-readable medium, where an instruction or a computer program is stored in the computer-readable medium, and when the instruction or the computer program runs on a device, the device is caused to perform any implementation of the comment display method provided in the embodiments of the present application.

It should be noted that the computer-readable medium in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatus or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program code is carried therein. This propagated data signal may take many forms, including but not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained in the computer-readable medium may be transmitted by any suitable medium, including but not limited to: wires, optical cables, radio frequency (RF), etc., or any suitable combination thereof.

In some implementations, the client and the server may communicate using any currently known or future developed network protocol, such as the Hypertext Transfer protocol (HTTP), and may be interconnected in any form or medium to digital data communication (for example, a communication network). Examples of the communication network include a local area network (“LAN”), a wide area network (“WAN”), an internetwork (for example, the Internet), a peer-to-peer network (for example, an Ad-Hoc peer-to-peer network), and any currently network or future-developed network.

The above-mentioned computer-readable medium may be contained in the electronic device or may exist independently without being assembled into the electronic device.

The above-mentioned computer-readable medium carries one or more programs that, when executed by the electronic device, cause the electronic device to perform the method described above.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be executed entirely on a user computer, partially on the user computer, as an independent software package, partially on the user computer and partially on a remote computer, or entirely on the remote computer or server. In the case of the remote computer, the remote computer may be connected to the user computer through any kind of network, including a local area network (LAN) or a wide area network (WAN), or may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by means of software, and may also be implemented by means of hardware. The name of a unit/module does not constitute a limitation on the unit itself under certain circumstances.

The functions described herein above may be performed at least partly by one or more hardware logic components. For example, without limitation, exemplary types of the hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semi-conductive system, apparatus or device, or any suitable combination of the above. More specific examples of the machine-readable storage medium would include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. For the same and similar parts between the various embodiments, reference may be made to each other. For the system or apparatus disclosed in the embodiments, since it corresponds to the method disclosed in the embodiments, the description is relatively simple, and the description of the related parts may refer to the description of the method.

It should be understood that in the present application, “at least one (item)” means one or more, and “a plurality of” means two or more. “And/or” is used to describe the association relationship between associated objects, and indicates that three relationships may exist, for example, “A and/or B” may indicate: only A exists, only B exists, and both A and B exist, where A and B may be singular or plural. The character “/” generally indicates that the associated objects before and after it are in an “or” relationship. “At least one of the following” or a similar expression thereof refers to any combination of these items, including any combination of a single item or plural items. For example, at least one of a, b, or c may represent: a, b, c, “a and b”, “a and c”, “b and c”, or “a and b and c”, where a, b, and c may be single or multiple.

It should also be noted that in this application, relational terms such as first and second are only used to distinguish one entity or operation from another entity or operation, and do not necessarily require or imply any actual relationship or order between these entities or operations. Moreover, terms “include”, “comprise”, or any other variation thereof are intended to cover non-exclusive inclusion, so that a process, method, object, or device including a series of elements includes not only those elements, but also other elements not explicitly listed or elements inherent to such process, method, object, or device. Without further restrictions, an element defined by a phrase “including one” does not exclude that there are other identical elements in the process, method, object, or device including the element.

The steps of the method or algorithm described in conjunction with the embodiments disclosed herein may be implemented directly by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

It should be noted that in the embodiments of the present application, no user sensitive information is involved, and all user-related information is acquired, used, and determined after user authorization. In an example, before obtaining the user-related information, the corresponding interface displays prompt information related to obtaining data use authorization, and the prompt information informs the user of the type, use range, use scenarios, etc., of personal information involved in the present disclosure in an appropriate manner in accordance with relevant laws and regulations, so that the user determines whether to agree to the authorization based on the prompt information. It should be understood that the above process of notifying and obtaining user authorization is only illustrative, and does not constitute a limitation on the implementations of the present disclosure. Other manners that satisfy the relevant laws and regulations may also be applied to the implementations of the present disclosure.

The above description of the disclosed embodiments enables those skilled in the art to implement or use the present application. Various modifications to these embodiments will be readily apparent to those skilled in the art, and the generic principles defined herein may be implemented in other embodiments without departing from the spirit or scope of the present application. Therefore, the present application will not be limited to the embodiments shown herein, but is to be accorded the widest scope consistent with the principles and novel features disclosed herein.

1. A website detection method, comprising:
obtaining website information of a first website to which a first file is sent out in response to an event that the first file is sent out through a first browser, wherein the first browser is a pre-configured browser allowed to be detected, and the first file is pre-configured to have a security protection attribute;
determining whether the first website matches a pre-configured website audit strategy based on the website information of the first website, wherein the website audit strategy is used to indicate whether a category of websites is allowed to be audited; and
generating an audit result in response to the first website matching the website audit strategy, wherein the audit result is used to indicate that, on the first browser, there exists a security risk of the first file is leaked to the first website.

2. The method of claim 1, further comprising:
providing a website audit strategy configuration channel; and
receiving the website audit strategy configured through the website audit strategy configuration channel, wherein the website audit strategy indicates a first category of websites to be skipped from auditing and/or a second category of websites that must be audited.

3. The method of claim 1, further comprising:
providing two audit modes comprising a first audit mode and a second audit mode, wherein the first audit mode is used to indicate that all behaviors of sending out to external websites are audited, and the second audit mode is used to indicate that behaviors of sending out to specified websites are audited, and wherein the second audit mode supports configuring and updating the specified websites; and
determining a selected audit mode as the pre-configured website audit strategy.

4. The method of claim 1, further comprising:
obtaining an event of operating a file through the first browser, excluding an event of performing a predefined secure operation through the first browser, and determining whether the event of sending out the first file through the first browser occurs, wherein the secure operation comprises at least one of: opening a local file by a browser, loading a browser plugin, loading a browser extension, and sending to a local server.

5. The method of claim 1, wherein obtaining the website information of the first website to which the first file is sent out comprises at least one of the following:
obtaining the website information of the first website based on user interface automation UI Automation callback information;
obtaining the website information of the first website by invoking accessibility (Accessibility);
obtaining the website information of the first website by invoking core graphics (CoreGraphics); and
obtaining the website information of the first website by parsing a session (Session) file, wherein the Session file is obtained by backup after Session update of the first browser is monitored.

6. The method of claim 1, further comprising:
providing a browser audit configuration channel, wherein the browser audit configuration channel provides all browsers installed on an office terminal for selection and configuration; and
determining a selected browser as the browser that is allowed to be detected.

7. The method of claim 1, further comprising:
generating and reporting an alarm, wherein the alarm comprises the website information of the first website, and the website information of the first website comprises at least one of: a uniform resource locator (URL), a website name, and a webpage title.

8. The method of claim 1, further comprising:
blocking, on the first browser, a response to the first website operating the first file.

9. The method of claim 1, wherein obtaining the website information of the first website to which the first file is sent out comprises:
triggering obtaining of the website information of the first website after a preset time has elapsed from perceiving occurrence of the event of sending out the first file through the target first browser.

10. (canceled)

11. An electronic device, comprising a processor and a memory, wherein
the memory is configured to store instructions or a program; and
the processor is configured to execute the instructions or the program in the memory to cause the electronic device to
obtain website information of a first website to which a first file is sent out in response to an event that the first file is sent out through a first browser, wherein the first browser is a pre-configured browser allowed to be detected, and the first file is pre-configured to have a security protection attribute;
determine whether the first website matches a pre-configured website audit strategy based on the website information of the first website, wherein the website audit strategy is used to indicate whether a category of websites is allowed to be audited; and
generate an audit result in response to the first website matching the website audit strategy, wherein the audit result is used to indicate that, on the first browser, there exists a security risk of the first file is leaked to the first website.

12. A non-transitory readable medium storing instructions or a program that, when executed by a processor, cause the processor to:
obtain website information of a first website to which a first file is sent out in response to an event that the first file is sent out through a first browser, wherein the first browser is a pre-configured browser allowed to be detected, and the first file is pre-configured to have a security protection attribute;
determine whether the first website matches a pre-configured website audit strategy based on the website information of the first website, wherein the website audit strategy is used to indicate whether a category of websites is allowed to be audited; and
generate an audit result in response to the first website matching the website audit strategy. wherein the audit result is used to indicate that, on the first browser, there exists a security risk of the first file is leaked to the first website.

13. (canceled)

14. The electronic device of claim 11, wherein the processor further causes the electronic device to:
provide a website audit strategy configuration channel; and
receive the website audit strategy configured through the website audit strategy configuration channel, wherein the website audit strategy indicates a first category of websites to be skipped from auditing and/or a second category of websites that must be audited.

15. The electronic device of claim 11, wherein the processor further causes the electronic device to:
provide two audit modes comprising a first audit mode and a second audit mode, wherein the first audit mode is used to indicate that all behaviors of sending out to external websites are audited, and the second audit mode is used to indicate that behaviors of sending out to specified websites are audited, and wherein the second audit mode supports configuring and updating the specified websites; and
determine a selected audit mode as the pre-configured website audit strategy.

16. The electronic device of claim 11, wherein the processor further causes the electronic device to:
obtain an event of operating a file through the first browser, exclude an event of performing a predefined secure operation through the first browser, and determine whether the event of sending out the first file through the first browser occurs, wherein the secure operation comprises at least one of: opening a local file by a browser, loading a browser plugin, loading a browser extension, and sending to a local server.

17. The electronic device of claim 11, wherein the processor causing the electronic device to obtain the website information of the first website to which the first file is sent out further causes electronic device to:
obtain the website information of the first website based on user interface automation UI Automation callback information;
obtain the website information of the first website by invoking accessibility (Accessibility);
obtain the website information of the first website by invoking core graphics (CoreGraphics); and
obtain the website information of the first website by parsing a session (Session) file, wherein the Session file is obtained by backup after Session update of the first browser is monitored.

18. The electronic device of claim 11, wherein the processor further causes the electronic device to:
provide a browser audit configuration channel, wherein the browser audit configuration channel provides all browsers installed on an office terminal for selection and configuration; and
determine a selected browser as the browser that is allowed to be detected.

19. The electronic device of claim 11, wherein the processor further causes the electronic device to:
generate and report an alarm, wherein the alarm comprises the website information of the first website, and the website information of the first website comprises at least one of: a uniform resource locator (URL), a website name, and a webpage title.

20. The electronic device of claim 11, wherein the processor further causes the electronic device to:
block, on the first browser, a response to the first website operating the first file.

21. The electronic device of claim 11, wherein the processor further causes the electronic device to:
trigger obtaining of the website information of the first website after a preset time has elapsed from perceiving occurrence of the event of sending out the first file through the first browser.

22. The readable medium of claim 12, wherein the instructions or the program further cause the processor to:
provide a website audit strategy configuration channel; and
receive the website audit strategy configured through the website audit strategy configuration channel, wherein the website audit strategy indicates a first category of websites to be skipped from auditing and/or a second category of websites that must be audited.
